(19) United States
(12) Patent Application Publication
(10) Pub. No.: US 2012/0030504 A1
(43) Pub. Date: Feb. 2, 2012

(54) HIGH RELIABILITY COMPUTER SYSTEM AND ITS CONFIGURATION METHOD

(75) Inventors: Hiroyasu Nishiyama, Kawasaki (JP); Tomoya Ohta, Sagamihara (JP); Daisuke Yokota, Hitachi (JP); Ken Nomura, Yokohama (JP); Toshiaki Arai, Machida (JP)

(73) Assignee: Hitachi, Ltd.

(21) Appl. No.: 13/201,579

(22) PCT Filed: Nov. 5, 2009
(86) PCT No.: PCT/JP2009/005872

§ 371 Date: Oct. 24, 2011

(30) Foreign Application Priority Data
Mar. 19, 2009 (JP) 2009-067299

(51) Int. Cl. G06F 11/20

(52) U.S. Cl. 714/4.11; 714/E11.071

(57) ABSTRACT

[Object]

To increase the speed of copy processing from an online computer 101 to a standby computer 102.

[Solution]

When copying copy target information from the online computer 101 to the standby computer 102, a status copy processing unit 110: recognizes, as a synchronous point, a point in time when execution of a first application (AP #1), from among applications 108, is completed; extracts only information stored in a use area 401 of an OS 106 and a use area 403 of a second application (AP #2) from a storage area 400 of a memory at this synchronous point; and transfers the extracted information, as the copy target information necessary to continue the processing, from the online computer 101 to the standby computer 102.

[Selected Drawing] FIG. 1

### TECHNICAL FIELD

The present invention relates to a technology of configuring a high reliability computer system for uses requiring high reliability.

### BACKGROUND ART

Mission-critical uses such as financial and public system fields require high availability of systems. On the other hand, the possibility of system failure occurrence attributable to, for example, hardware faults, due to achievement of high hardware performance and aggregation of businesses using a virtualization mechanism is assumed to increase more than before.

As one means for realizing such high availability, there is a known system configuration technique called “clustering” whereby an online system and a standby system are prepared and the online system is switched to the standby system when a problem occurs in the online system.

As clustering methods, the following methods are known: (a) a method of preventing the online system from maintaining a processing status and only switching from the online system to the standby system when detecting a failure of the online system; and (b) a method of making the status of the operation system correspond with the status of the standby system and recovering processing executed at the time of a failure detection when detecting the failure. Since it is difficult to make the online system retain the status by the method (a), the method (b) has higher applicability.

In order to realize high reliability by the method (b) as described above, it is necessary to make the status of the online system correspond with that of the standby system. For this purpose, there are the following methods: (1) a method of making the status of the two systems always correspond with each other by operating the same command sequence on the two systems simultaneously and in parallel by using, for example, a special hardware mechanism; and (2) a method of periodically copying the status of a memory for the online system to the standby system and buffering I/O operations between the online system and the standby system, thereby periodically configuring a point where the execution of the standby system can be resumed.

Regarding the method (2), there is a technique of buffering the I/O status on the online system until the completion of synchronization of the memory status, reflecting the I/O status at the time of completion of synchronization between the systems, setting this point in time as a restart point, and rerunning the standby system from the restart point when detecting a failure (see Non-patent Literature 1).

This technique allows the online system and the standby system to operate software including an OS on a hypervisor and perform, by the functions of the hypervisor, memory synchronization between the systems as described above and I/O buffering. The hypervisor virtualizes the entire hardware system for executing applications and the OS by means of software (system virtualization).

### CITATION LIST

### Non-Patent Literature

[NPL 1] Y. Tamura, Kemari: Virtual Machine Synchronization for Fault Tolerance using DomT, Xen Summit Boston 2008, 2008.

### DISCLOSURE OF INVENTION

### Problems to be Solved by the Invention

With the method for configuring the conventional high reliability computer system which uses only the system virtualization, no consideration is given to the operation of software operating on the system virtualization. Accordingly, information of an area which might be judged to be unused depending on the software execution status will also be considered as copy target information and the information of the unused area will also be copied along with the status synchronization. Furthermore, the information of the unused area is redundant; and when configuring the high reliability computer system, the speed of the copy processing will not be increased and the system performance will degrade.

The present invention was devised in light of the above-described problems of the conventional technology and it is an object of the invention to provide a high reliability computer system and its configuration method capable of increasing the speed of copy processing.

### Means for Solving the Problems

In order to achieve the above-described object, the present invention is characterized in that it monitors the status of programs of an online computer and detects a synchronous point for performing status synchronization between the online computer and a standby computer, extracts only information to continue the processing after the synchronous point as copy target information from a storage device of the online computer, and copies the extracted copy target information from the online computer to the standby computer.

### Advantageous Effects of Invention

According to the present invention, the execution performance of the high reliability computer system can be enhanced by increasing the speed of the copy processing.

### BRIEF DESCRIPTION OF DRAWINGS

FIG. 1 is a configuration diagram of a high reliability computer system, which shows an embodiment of the present invention.

FIG. 2 is a configuration diagram explaining I/O buffering processing.

FIG. 3 is a sequence diagram explaining processing of the online computer and the standby computer.

FIG. 4(a) is a status diagram showing the status of a memory during execution of applications and FIG. 4(b) is a status diagram showing the status of the memory at the time of termination of an application.

FIG. 5 is a flowchart explaining actions of the high reliability computer system when the time of termination of the application is set as a synchronous point.

FIG. 6 is a flowchart explaining synchronous point judgment processing when the time of termination of the application is set as the synchronous point.

FIG. 7(a) is a status diagram showing the status of the memory at the time of termination of a processing phase #1 and FIG. 7(b) is a status diagram showing the status of the memory at the time of termination of a processing phase #2.

FIG. 8 is a flowchart explaining synchronous point judgment processing when the time of switching the processing phase is set as the synchronous point.

FIG. 9(a) is a status diagram showing the status of the memory before GC completion and FIG. 9(b) is a status diagram showing the status of the memory after the GC completion.

FIG. 10 is a flowchart explaining the synchronous point judgment processing when the time of the GC completion is set as the synchronous point.

FIG. 11 is a diagram explaining the configuration of an API for designating a synchronous point and a non-target area.

### DESCRIPTION OF EMBODIMENTS

### First Embodiment

A first embodiment of the present invention will be explained with reference to the relevant drawings. This embodiment is designed so that a termination point of an application program (hereinafter referred to as the “application”) is set as a synchronous point, thereby preventing copying of information of an unnecessary area (unused area).

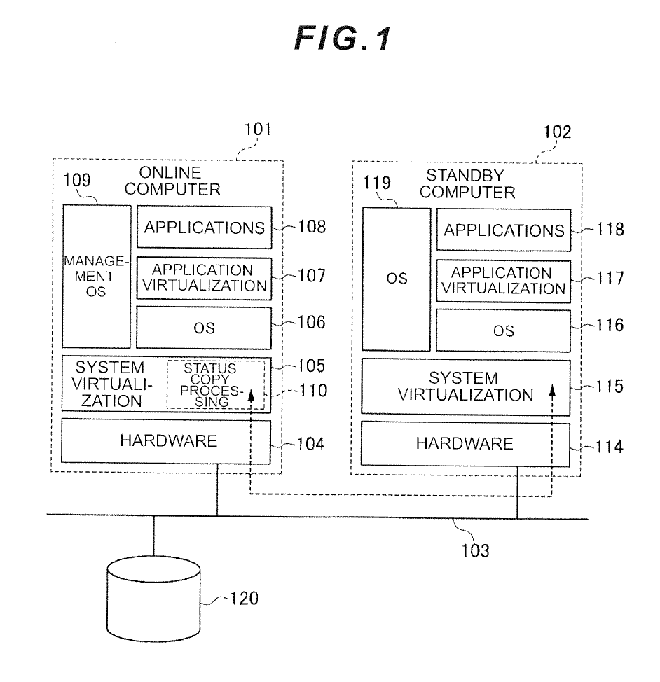

FIG. 1 is a configuration diagram of a high reliability computer system, which shows the first embodiment of the present invention. The high reliability computer system is constituted from an online computer 101 and a standby computer 102; and the online computer 101 and the standby computer 102 are connected via a coupling network 103 such as a network or a bus and are also connected to a shared external storage device 120 via the coupling network 103.

The online computer 101 is equipped with hardware 104 as an online-system hardware resource as well as, as online-system software resources, a system virtualization processing unit 105, an application execution OS (Operating System) 106, an application virtualization processing unit 107, applications 108, and an management OS 109.

The standby computer 102 has basically the same configuration as that of the online computer 101 and is equipped with hardware 114 as a standby-system hardware resource as well as, as standby-system software resources, a system virtualization processing unit 115, an application execution OS 116, an application virtualization processing unit 117, applications 118, and a management OS 119.

The hardware 104, 114 includes, for example, input/output devices, a storage device (hereinafter referred to as the “memory”), and a processing unit (any of which is not shown in the drawing). Each memory stores a plurality of programs including control programs and processing programs and also stores information constituting each software resource.

The system virtualization processing unit 105 virtualizes the hardware 104 and executes processing on the application execution OS (Operating System) 106, the application virtualization processing unit 107, the applications 108, and the management OS 109; and the application virtualization processing unit 107 virtualizes the applications 108 and executes processing on the application execution OS 106.

For example, the system virtualization processing unit 105 monitors an execution status of the application execution OS and the applications 108 and detects a synchronous point for performing status synchronization with the standby computer 102; extracts copy target information necessary to continue the processing from the memory at the detected synchronous point; and transfers the extracted copy target information via the coupling network 103 to the standby computer 102.

Specifically speaking, the system virtualization processing unit 105 includes a status copy processing unit 110 which is characteristic processing of the present invention. This status copy processing unit 110 extracts status information about the status of the memory used by the OS 106, the application virtualization processing unit 107, and the applications 108, which operate on the system virtualization processing unit 105, as copy target information, transfers the extracted status information via the coupling network 103 to the standby computer 102, and gives instruction to the standby computer 102 to copy the status information.

Meanwhile, if a failure occurs in the online computer 101, processing by the online computer 101 is switched to processing by the standby computer 102; and the standby computer 102 executes operation based on the status information copied from the online computer 101. As a result, with respect to the high reliability computer system, even if a failure occurs in the online computer 101, the processing by the online computer 101 is continued by the standby computer 102.

In order to switch the operation from the online computer 101 to the standby computer 102, it is necessary to reproduce the I/O operation which occurred between the point in time of copying the status information and the point in time of the failure occurrence.

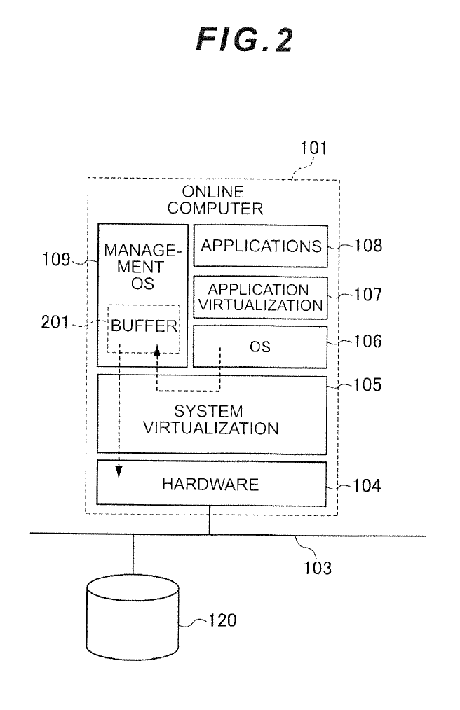

Therefore, as shown in FIG. 2, the online computer 101 sends the I/O operation, which was issued from the OS 106 to the system virtualization processing unit 105, to the management OS 109 once; the I/O operation is then buffered at the management OS 109; and data associated with buffering is retained by the buffer 201. The I/O operation buffered at the management OS 109 is reflected by the system virtualization unit 105 from the buffer 201 to the hardware 104 when copying of the status information from the online computer 101 to the standby computer 102 is completed. The I/O operation reflected in the hardware 104 is buffered in the same manner at the online computer 101 and the standby computer 102 by sending externally input information to the online computer 101 and the standby computer 102.

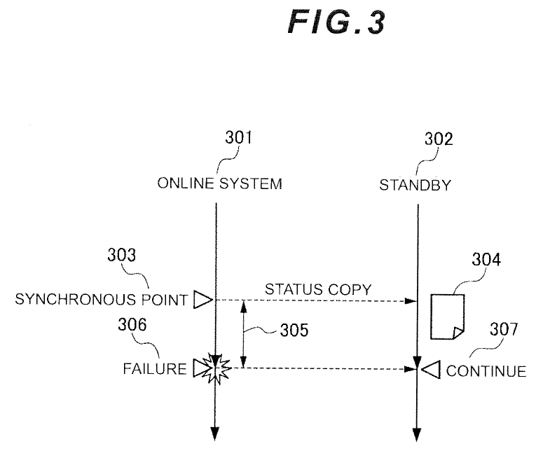

This sequence is shown in FIG. 3. FIG. 3 shows a processing sequence 301 of the online computer 101 and a processing sequence 302 of the standby computer 102. Firstly, when the online computer 101 detects a synchronous point 303, the online computer 101 copies the status information 304 of the memory to the standby computer 102 at this synchronous point 303. Then, the online computer 101 buffers I/O operation after the synchronous point 303 (305).

Next, if a failure occurs in the process of buffering of the I/O operation by the online computer 101, switching from the online computer 101 to the standby computer 102 is executed at a failure occurrence point 306. If this switching is executed, the standby computer 102 continues the processing based on the copied status information 304 at a start point 307 corresponding to the failure occurrence point 306.

When this happens, the I/O operation after the synchronous point 303 until the failure occurrence point 306 is not reflected in the status information 304, so that the standby computer 102 resumes the processing based on the copied status information 304 at the start point 307. As a result, with respect to the high reliability computer system, even if a failure occurs in the online computer 101, the processing at the online computer 101 will be continued by the standby computer 102.

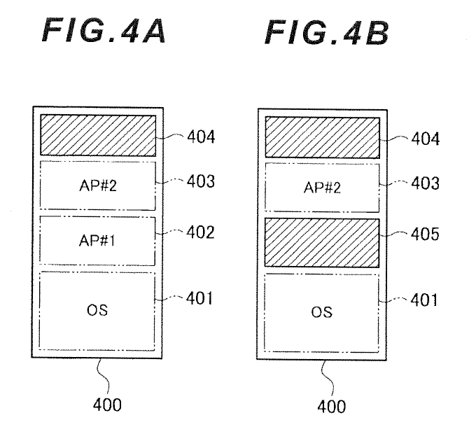

Next, the status of the memory in association with the execution of the applications 108 is shown in FIGS. 4(a) and 4(b). FIG. 4(a) shows the status of the memory during execution of the applications 108. In this case, a storage area 400 of the memory is constituted from a use area 401 of the OS 106, a use area 402 of a first application (AP #1), a use area 403 of a second application (AP #2), and an unused area 404.

FIG. 4(b) shows a state where the execution of the first application (AP #1) is terminated (completed). In this case, the storage area 400 of the memory is constituted from the use area 401 of the OS 106, an execution terminated area 405, the use area 403 of the second application (AP #2), and the unused area 404. The execution terminated area 405 is an area corresponding to the use area 402, which was used by the first application (AP #1), and is considered as an unused area.

Now, if all pieces of information in the storage area 400 of the memory are copied from the online computer 101 to the standby computer 102 without considering the status of the applications 108 as in a conventional high reliability computer system, all the pieces of information about the use area 401 of the OS 106, the use area 402 of the first application (AP #1), the use area 403 of the second application (AP #2), and the unused area 404 will be copied from the online computer 101 to the standby computer 102.

In this case, the content of the unused area 404 and the execution terminated area 405 is not necessary in order to continue the processing at the standby computer 102 in the status shown in FIG. 4(b). So, if all the pieces of information in the storage area 400 of the memory are copied from the online computer 101 to the standby computer 102 regardless of the completion of the execution of the first application (AP #1), the unnecessary information to continue the processing at the standby computer 102 will also be copied, so that an excessive amount of time will be required to copy the status information and the processing speed will decrease.

Therefore, in this embodiment, the termination point of an application 108 is set as the synchronous point and information of an unnecessary area (unused area) is not copied, thereby increasing the processing for copying the status information.

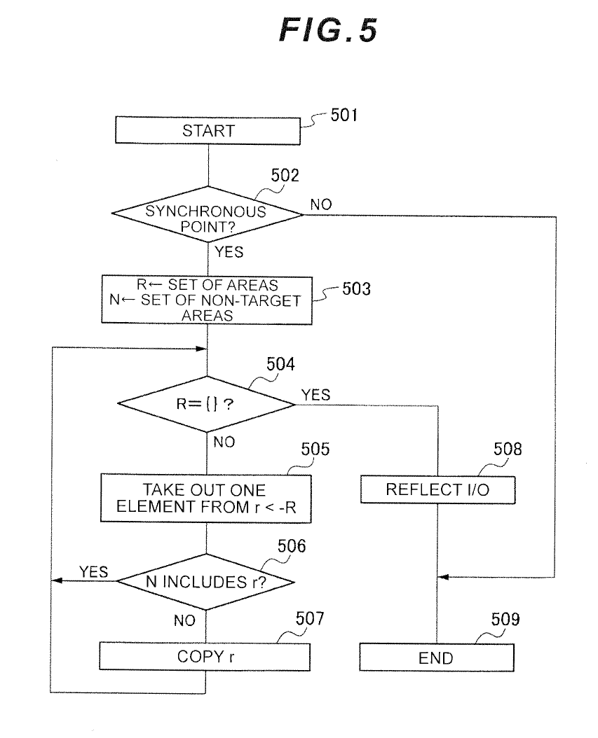

Next, actions performed when setting the termination point of the application 108 as the synchronous point will be explained with reference to a flowchart in FIG. 5. Processing shown in FIG. 5 is executed by the status copy processing unit 110 in the system virtualization processing unit 105. The processing by the status copy processing unit 110 is activated in response to an appropriate factor in the process of realizing the system virtualization.

Firstly, the status copy processing unit 110 starts processing in step 501; then examines the operation of the OS 106, the application virtualization processing unit 107, and the applications 108, which operate on the system virtualization processing unit 105; and judges whether it is a synchronous point or not, based on the execution status of the applications 108 (step 502). If the execution of an application 108 is terminated, the status copy processing unit 110 proceeds to processing in step 503; and if the execution of the application is not terminated, the status copy processing unit 110 proceeds to processing in step 509 and then terminates the processing in this routine.

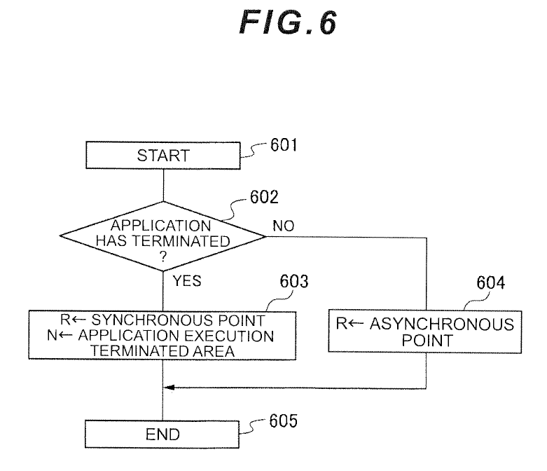

The specific processing content in step 502 is shown in FIG. 6. In the processing shown in FIG. 6, judgment of the synchronous point and calculation of a set of non-target areas are executed by the status copy processing unit 110.

Firstly, the status copy processing unit 110 starts processing in step 601 and then judges whether the application 108 has been terminated or not (step 602). If it is determined in step 602 that the application 108 has been terminated, the status copy processing unit 110 recognizes that point in time as a synchronous point, sets a judged value S as, for example, “1,” and sets a non-target area N as an execution terminated area for which the execution of the application has been terminated (step 603); and then the status copy processing unit 110 proceeds to step 605 and terminates the processing in this routine.

In this case, if the execution of the first application (AP #1), from among the applications 108, is terminated and the storage area 400 of the memory is configured as shown in FIG. 4(b), the execution terminated area 405 corresponding to the use area 402 used by the application (AP #1) is excluded from a copy target and is recognized as the non-target area N.

On the other hand, if it is determined in step 602 that the application 108 has not been terminated, the status copy processing unit 110 recognizes that point in time as a asynchronous point, and sets the judged value S as, for example, “0” (step 604); and then proceeds to step 605 and terminates the processing in this routine.

In this case, for example, if the storage area 400 of the memory is configured as shown in FIG. 4(a) and the first application (AP #1) and the second application (AP #2) are in an executed state, the status copy processing unit 110 determines that this is not the synchronous point.

If the synchronous point judgment processing is terminated and it is determined that it is the synchronous point, the status copy processing unit 110 proceeds processing in step 503 in FIG. 5. In step 503, the status copy processing unit 110 calculates, as variable R, a set of areas used by the OS 106, the application virtualization processing unit 107, and the applications 108, which operate on the system virtualization processing unit 105, and calculates a set of non-copy-target areas as variable N.

For example, if the execution of the first application (AP #1), from among the applications 108, is terminated and the storage area 400 of the memory is configured as shown in FIG. 4(b), the storage area 400 of the memory is divided into four areas (the use area 401 of the OS 106, the execution terminated area 405, the use area 403 of the second application (AP #2), and the unused area 404), so that the variable R for a set of areas is calculated as 4 and the variable N for a set of non-target areas is calculated as 2. In this case, the set of non-target areas is constituted from the execution terminated area 405 and the unused area 404.

Next, the status copy processing unit 110 judges whether the variable R for the set of areas is an empty set or not (step 504). If the variable R for the set of areas is not an empty set, the status copy processing unit 110 proceeds to processing in step 505 and takes out one element from the variable R for the set of areas to variable r. Subsequently, the status copy processing unit 110 judges whether the variable r is included in the variable N for the set of non-target areas or not (step 506); and if the variable r is included in the variable N for the set of non-target areas, the status copy processing unit 110 returns to the processing in step 504 and repeats the processing from step 504 to step 506 until the variable R for the set of areas becomes an empty set.

If it is determined in step 506 that the variable r is not included in the variable N for the set of non-target areas, the status copy processing unit 110 proceeds to step 507 and executes processing for copying information stored in the use area 401 of the OS 106 and the use area 403 of the second application (AP #2), which are areas excluded from the non-target areas, that is, copy target areas, as copy target information from the online computer 101 to the standby computer 102.

Furthermore, if it is determined in step 504 that the variable R for the set of areas is an empty set, the status copy processing unit 110 recognizes that all pieces of the copy target information have been copied from the online computer 101 to the standby computer 102; proceeds to processing in step 508; reflects the buffered I/O operation in the hardware 104; proceeds to processing in step 509; and then terminates the processing in this routine.

According to this embodiment, the point in time when the execution of the first application (AP #1), from among the applications 108, is terminated is set as a synchronous point; only the information stored in the use area 401 of the OS 106 and the use area 403 of the second application (AP #2) (information belonging to the application program to be used after the synchronous point), from among the storage area 400 of the memory, is extracted at this synchronous point; and the extracted information is copied, as the copy target information necessary to continue the processing, from the online computer 101 to the standby computer 102. As a result, it is possible to increase the speed of the processing for copying the necessary information to continue the processing and it is also possible to contribute to enhancement of the execution performance of the high reliability computer system.

In this embodiment, the point in time when the execution of the first application (AP #1), from among the applications 108, is terminated is set as the synchronous point; however, the point in time when the execution of the second application (AP #2) is terminated can be also set as the synchronous point. In this case, only information stored in the use area 401 of the OS 106 is copied, as the copy target information necessary to continue the processing, from the online computer 101 to the standby computer 102.

### Second Embodiment

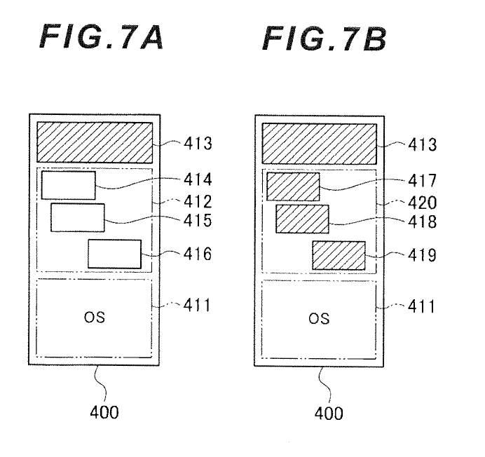

Next, a second embodiment of the present invention will be explained with reference to FIG. 7. This embodiment is designed so that a switching point of processing phases constituting the applications 108 is set as a synchronous point; and other elements of the configuration are similar to those of the first embodiment.

Firstly, as the status of the memory when the applications 108 are constituted from a plurality of processing phases #1 to #n, for example, the status of the memory at the first processing phase #1 is shown in FIG. 7(a) and the status of the memory at the second processing phase #2 is shown in FIG. 7(b).

The storage area 400 of the memory shown in FIG. 7(a) is constituted from an OS use area 411 and a use area 412 and unused area 413 of the applications 108. The use area 412 of the applications 108 includes application use areas 414, 415, 416 which are used only at the first processing phase #1. So, if the programs proceed to the second processing phase #2, the application use areas 414, 415, 416 at the first processing phase #1 become execution terminated areas 417, 418, 419, respectively, indicating that their respective processing phases are terminated; and the use area 412 of the applications 108 becomes an application use area 420.

If all pieces of information in the storage area 400 of the memory are copied from the online computer 101 to the standby computer 102 without considering the status of the applications 108 as in the conventional high reliability computer system, all pieces of information about the OS use area 411 and the use area 412 or 420 and unused area 413 of the applications will be copied from the online computer 101 to the standby computer 102.

In this case in the status shown in FIG. 7(b), the content of the unused area 413 and the execution terminated areas 417, 418, 419 are not necessary to continue the processing at the standby computer 102.

Therefore, if all the piece of the information in the storage area 400 of the memory are copied from the online computer 101 to the standby computer 102 regardless of the termination of the execution of the first processing phase #1, the unnecessary information to continue the processing at the standby computer 102 will also be copied, so that an excessive amount of time will be required to copy the status information and the processing speed will decrease.

So, in this embodiment, the switching point of the processing phases is set as the synchronous point and the information of the unnecessary areas (the unused area 413 and the execution terminated areas 417, 418, 419) is not copied, thereby increasing the processing for copying the status information.

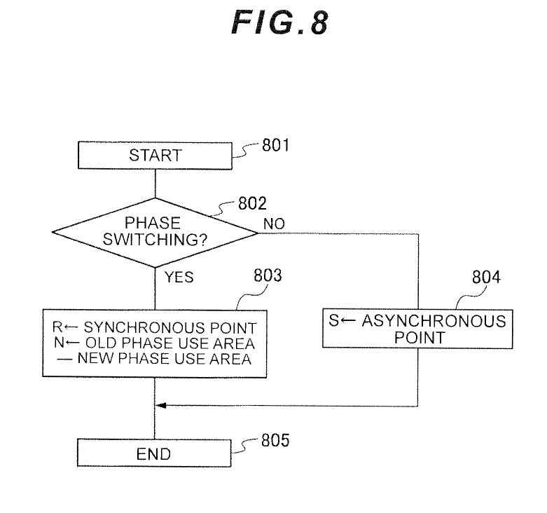

Next, actions performed when the switching point of the processing phases is set as the synchronous point will be explained with reference to a flowchart in FIG. 8. Incidentally, since the processing in this embodiment is the same as that of the first embodiment except judgment of the synchronous point and setting of the non-target area N, only the judgment of the synchronous point and processing for setting the non-target area N will be explained with respect to this embodiment. Furthermore, the processing shown in FIG. 8 is executed by the status copy processing unit 110 for the system virtualization processing unit 105.

Firstly, the status copy processing unit 110 starts processing in step 801 and then monitors the execution status of the applications 108 and judges whether a processing phase has terminated or not (step 802). If it is determined in step 802 that, for example, the processing phase #1 has terminated, the status copy processing unit 110 recognizes that point in time as a synchronous point, sets a judged value S as, for example, “1” and sets the non-target area N as an execution terminated area for which the execution of the processing phase is terminated (step 803); and then the status copy processing unit 110 proceeds to step 805 and then terminates the processing in this routine.

In this case, if the execution of the first processing phase #1, from among the applications 108, is completed and the storage area 400 of the memory is configured as shown in FIG. 7(b), the application use areas 414, 415, 416 at the first processing phase #1 are recognized respectively as the execution terminated areas 417, 418, 419 and then excluded from copy targets and set as the non-target area N.

Specifically speaking, the status copy processing unit 110 executes processing for setting areas (the execution terminated areas 417, 418, 419 and the unused area 413), which are obtained by excluding the use area 420 of the new processing phase (the processing phase #2) from the use area 412 of the old processing phase (the processing phase #1), as the non-target area N excluded from the copy targets.

On the other hand, if it is determined in step 802 that the processing phase has not been terminated, the status copy processing unit 110 recognizes that point in time as an asynchronous point, and sets the judged value S as, for example, “0” (step 8004), and then proceeds to step 805 and terminates the processing in this routine.

According to this embodiment, the switching point of the processing phases when the execution of the first processing phase #1, from among the applications 108, is terminated is set as the synchronous point; only the information (information belonging to the processing phase to be used after the synchronous point) stored in the use area 411 of the OS 106 and the area, which is obtained by excluding the execution terminated areas 417, 418, 419 from the application use area 420, is extracted from the storage area 400 of the memory at this synchronization point; and the extracted information is copied, as the copy target information necessary to continue the processing, from the online computer 101 to the standby computer 102. As a result, it is possible to increase the speed of the processing for copying the necessary information to continue the processing and it is also possible to contribute to enhancement of the execution performance of the high reliability computer system.

According to this embodiment, the switching point of the processing phases when the execution of the first processing phase #1, from among the applications 108, is terminated is set as the synchronous point; however, it is possible to set a switching point of the processing phases when the execution of another processing phase is terminated, as the synchronous point. In this case, only information belonging to the processing phase to be used after the synchronous point will be copied, as the copy target information necessary to continue the processing, from the online computer 101 to the standby computer 102.

### Third Embodiment

Next, a third embodiment of the present invention will be explained with reference to the relevant drawings. This embodiment is designed so that a point in time when an unused area of the applications 108 is determined is set as a synchronous point; and other elements of the configuration are similar to those of the first embodiment.

Specifically speaking, this embodiment is designed so that when the application virtualization processing unit 107 is an execution system equipped with garbage collection (GC), a point in time when an unused area is determined by the garbage collection (GC) is set as the synchronous point.

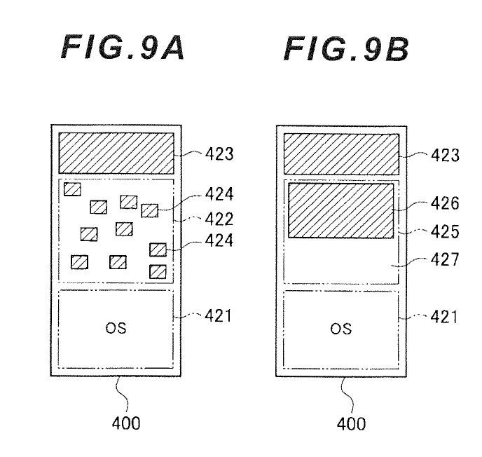

FIG. 9(a) shows the status of the memory before the garbage collection (GC) and FIG. 9(b) shows the status of the memory after the garbage collection (GC).

The storage area 400 of the memory shown in FIG. 9(a) is constituted from an OS use area 421 and a use area 421 and unused area 423 of applications. A plurality of unused data areas 424 exist in a scattered matter in the application use area 421.

Now, if all pieces of information in the storage area 400 of the memory are copied from the online computer 101 to the standby computer 102 without considering the status of the applications 108 as in the conventional high reliability computer system, all pieces of information about the OS use area 421 and the use area 421 and unused area 423 of the applications will be copied from the online computer 101 to the standby computer 102.

In this case in the status shown in FIG. 9(a), the content of the unused area 423 and the plurality of unused data areas 424 are not necessary to continue processing at the standby computer 102.

So, if all the pieces of information in the storage area 400 of the memory are copied from the online computer 101 to the standby computer 102 in a state where the plurality of unused data areas 424 belonging to the use area 421 of the applications 108 are not determined, unnecessary information to continue the processing at the standby computer 102 will also be copied, so that an excessive amount of time will be required to copy the status information and the processing speed will decrease.

Therefore, this embodiment is designed so that a point in time when the unused area is determined by the garbage collection (GC) is set as the synchronous point and information of the unnecessary areas (the unused area 423 and the plurality of unused data areas 424) is not copied, thereby increasing the speed of the processing for copying the status information.

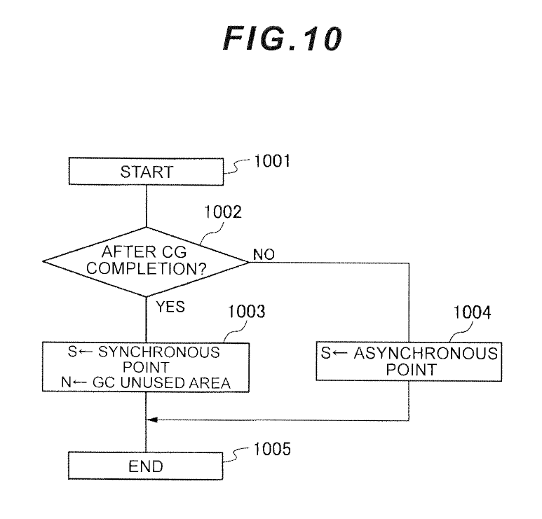

Next, actions performed when the point in time when the unused area is determined by the garbage collection (GC) is set as the synchronous point will be explained with reference to a flowchart in FIG. 10. Incidentally, since processing in this embodiment is the same as the first embodiment except judgment of the garbage collection (GC) and setting of the non-target area N, only the judgment of the garbage collection (GC) and processing for setting the non-target area N will be explained with respect to this embodiment. Furthermore, the processing shown in FIG. 10 is executed by the application virtualization processing unit 107 and the status copy processing unit 110.

Firstly, the status copy processing unit 110 starts processing in step 1001, gives instruction to the application virtualization processing unit 107 to execute the garbage collection (GC), and judges whether the garbage collection (GC) is completed or not (step 1002).

At that time, the application virtualization processing unit 107 executes processing, by using the garbage collection (GC), for collecting information about the plurality of unused data areas 424 belonging to the application virtualization use area 421, storing the collected information in an unused data area 426 of the application virtualization use area 425 as shown in FIG. 9(b), and configuring the application virtualization use area 425 by dividing it into the unused data area 426 for storing unused data and an in-use data area 427 for storing data in use; and when the unused data area 426 is determined (when collection of unused data is terminated), the application virtualization processing unit 107 notifies the status copy processing unit 110 to that effect.

When the status copy processing unit 110 receives notice from the application virtualization processing unit 107 to report that the unused data area 426 is determined, it recognizes that point in time when the unused area is determined by the completion of the garbage collection (GC), as the synchronous point, sets the judged value S as, for example, “1,” and sets the non-target area N as the unused area determined by the completion of the garbage collection (GC) (step 1003); and then the status copy processing unit 110 proceeds to step 1005 and then terminates the processing in this routine.

If the unused area is determined by the completion of the garbage collection (GC) and the storage area 400 of the memory is configured as shown in FIG. 9(b), the unused data area 426 in the application virtualization use area 425 is excluded from copy target areas and is set as the non-target area N.

In this case, the status copy processing unit 110 executes processing for copying information stored in the use area 421 of the OS 106 and the in-use data area 427, which are different from the non-target area N, that is, which are the copy targets, from the online computer 101 to the standby computer 102.

On the other hand, if it is determined in step 1002 that the garbage collection (GC) is not completed, the status copy processing unit 110 recognizes that point in time as an asynchronous point and sets the judged value S as, for example, “0” (step 1004), and then proceeds to step 805 and terminates the processing in this routine.

According to this embodiment, the point in time when the unused area is determined by the completion of the garbage collection (GC) is set as the synchronous point; only the information stored in the use area 421 of the OS 106 and the in-use data area 427 in the application virtualization use area 425 is extracted as information stored in the storage area 400 of the memory at this synchronization point; and the extracted information is copied, as the copy target information necessary to continue the processing, from the online computer 101 to the standby computer 102. As a result, it is possible to increase the speed of the processing for copying the necessary information to continue the processing and it is also possible to contribute to enhancement of the execution performance of the high reliability computer system.

### Fourth Embodiment

Next, a fourth embodiment of the present invention will be explained with reference to the relevant drawings. This embodiment is designed so that a synchronous point and a non-target area are designated by an API (Application Programming Interface) cell from the OS 106, the application virtualization processing unit 107, or the applications 108, which operate on the system virtualization processing unit 105, a point in time designated by the API is set as the synchronous point, and the status copying of an unused area is not performed, thereby increasing the speed of the status copy processing; and other elements of the configuration are similar to those of the first embodiment.

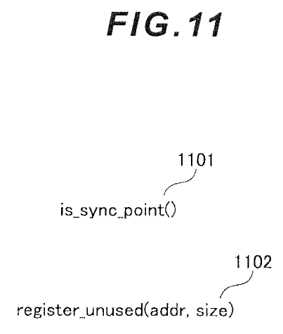

Specifically speaking, when creating a program, for example, when creating a program for the applications 108, information about the API is created in advance in information about the execution of the application 108 as shown in FIG. 11.

For example, an API 1101 indicating that a point in time indicative of termination of a certain application or a point in time indicative of a switching point of processing phases, from among points in time in the program for the application 108, is set as a call point and this call point is a synchronous point, is created in advance, using a function “is_sync_point”; and an API 1102 indicating a non-target area (area that is not a target of the status copying, for example, the execution terminated area 405 and the unused area 404 in the case of FIG. 4(b)) which is different from a copy target area is created in advance, using a function “register_unused”.

If the API 1101 and the API 1102 are created in the applications 108 and when the application 108 reaches the API 1101 during the process of its processing, instruction is given as triggered by the API call to the system virtualization processing unit 105 to set the call point as the synchronous point and also designate the API 1102 as the non-target area which is different from the copy target area.

In response to these instructions, the system virtualization processing unit 105 determines based on the API call that it is the synchronous point; and if, for example, the storage area 400 of the memory is as shown in FIG. 4(b) as information of the copy target area, which is different from the non-target area designated by the API 1102 from among the storage area 400 of the memory at this synchronous point, only information stored in the use area 401 of the OS 106 and the use area 403 of the second application (AP #2) (for example, an application program to be used after the synchronous point) is extracted and the extracted information is copied, as copy target information necessary to continue the processing, from the online computer 101 to the standby computer 102.

According to this embodiment, in response to the API call from the application 108, this API call point is set as the synchronous point; only information of the copy target area, which is different from the non-target area designated by the API 1102, is extracted from the storage area 400 of the memory at this synchronous point; and the extracted information is copied, as copy target information necessary to continue the processing, from the online computer 101 to the standby computer 102. Therefore, it is possible to increase the speed of the processing for copying the necessary information to continue the processing and it is also possible to contribute to enhancement of the execution performance of the high reliability computer system.

### INDUSTRIAL APPLICABILITY

The present invention can be used for the high reliability computer system composed of the online computer 101 and the standby computer 102 in order to enhance the performance required to copy the status between the online computer 101 and the standby computer 102.

### REFERENCE SIGNS LIST

101 Online computer
102 Standby computer
103 Coupling network
104, 114 Hardware
105, 115 System virtualization processing unit
106, 116 OS
107, 117 Application virtualization processing unit
108, 118 Application
109, 119 Management OS
110 Status copy processing unit

1. A computer system comprising:
an online computer having an online-system hardware resource including an input/output device, a storage device, and a processing unit, and an online-system software resource stored in the storage device, for operating the online-system hardware resource; and
a standby computer having a standby-system hardware resource corresponding to the online-system hardware resource and a standby-system software resource corresponding to the online-system software resource, the standby computer being connected the online computer via a coupling network;
wherein the online-system software resource is equipped with a system virtualization processing unit with a plurality of programs, for virtualizing the hardware resource with respect to the plurality of programs, monitoring a status of the plurality of programs, and processing information of the storage device; and
wherein the system virtualization processing unit monitors an execution status of the programs, detects a synchronous point for performing status synchronization with the standby computer, extracts copy target information necessary to continue processing from the storage device at the detected synchronous point, and transfers the extracted copy target information via the coupling network to the standby computer.

2. The computer system according to claim 1, wherein the system virtualization processing unit monitors an execution status of a plurality of application programs stored in the storage device, from among the programs, detects a termination point of any application program from among the plurality of application programs as the synchronous point, and extracts an application program to be used after the synchronous point as the copy target information from the storage device.

3. The computer system according to claim 1, wherein the system virtualization processing unit monitors an execution status of a plurality of processing phases constituting an application program stored in the storage device, from among the programs, detects a termination point of any processing phase from among the plurality of processing phases as the synchronous point, and extracts information belonging to a processing phase to be used after the synchronous point as the copy target information from the storage device.

4. The computer system according to claim 1, wherein the online-system software resource includes an application virtualization processing unit for collecting garbage collection target data from a storage area for storing an application program from among the programs and configuring the storage area by dividing it into an in-use data storage area for storing data used by the application program and an unused data storage area for storing the collected garbage collection target data; and
wherein the system virtualization processing unit sets a point in time when the unused data storage area is determined in the storage area by the application virtualization processing unit, as the synchronous point and extracts data stored in the in-use data storage area as the copy target information from the storage device.

5. The computer system according to claim 1, wherein the system virtualization processing unit monitors an execution status of a plurality of application programs stored in the storage device, from among the programs, detects a synchronous point designated by an application programmable interface described in each application program as the synchronous point, and extracts an application program, which is information other than information designated by the application programmable interface and is to be used after the synchronous point, as the copy target information from the storage device.

6. A method for configuring a computer system including:
an online computer having an online-system hardware resource including an input/output device, a storage device, and a processing unit, and an online-system software resource stored in the storage device, for operating the online-system hardware resource; and
a standby computer having a standby-system hardware resource corresponding to the online-system hardware resource and a standby-system software resource corresponding to the online-system software resource, the standby computer being connected the online computer via a coupling network;
wherein the online-system software resource is equipped with a system virtualization processing unit with a plurality of programs, for virtualizing the hardware resource with respect to the plurality of programs, monitoring a status of the plurality of programs, and processing information of the storage device; and
wherein the system virtualization processing unit executes:
a step of monitoring an execution status of the programs and detecting a synchronous point for performing status synchronization with the standby computer;
a step of extracting copy target information necessary to continue processing from the storage device at the synchronous point detected in the above step; and
a step of transferring the copy target information extracted in the above step via the coupling network to the standby computer.

7. The computer system configuration method according to claim 6, wherein the system virtualization processing unit executes:
a step of monitoring an execution status of a plurality of application programs stored in the storage device, from among the programs, and detecting a termination point of any application program from among the plurality of application programs as the synchronous point; and
a step of extracting an application program to be used after the synchronous point as the copy target information from the storage device.

8. The computer system configuration method according to claim 6, wherein the system virtualization processing unit executes:
a step of monitoring an execution status of a plurality of processing phases constituting an application program stored in the storage device, from among the programs, and detecting a termination point of any processing phase from among the plurality of processing phases as the synchronous point; and
a step of extracting information belonging to a processing phase to be used after the synchronous point as the copy target information from the storage device.

9. The computer system configuration method according to claim 6, wherein the online-system software resource includes an application virtualization processing unit for collecting garbage collection target data from a storage area for storing an application program from among the programs and configuring the storage area by dividing it into an in-use data storage area for storing data used by the application program and an unused data storage area for storing the collected garbage collection target data; and
wherein the system virtualization processing unit executes:
a step of setting a point in time when the unused data storage area is determined in the storage area by the application virtualization processing unit, as the synchronous point; and
a step of extracting data stored in the in-use data storage area as the copy target information from the storage device.

10. The computer system configuration method according to claim 6, wherein the system virtualization processing unit executes:
a step of monitoring an execution status of a plurality of application programs stored in the storage device, from among the programs and detecting a synchronous point designated by an application programmable interface described in each application program as the synchronous point; and
a step of extracting an application program, which is information other than information designated by the application programmable interface and is to be used after the synchronous point, as the copy target information from the storage device.
